(19) United States
(12) Patent Application Publication
(10) Pub. No.: US 2007/0291401 A1
(43) Pub. Date: Dec. 20, 2007

(54) CONTACT DETECTION USING CALIBRATED SEEKS

(75) Inventors: Yu Sun, Fremont, CA (US); Craig Smith, Santa Clara, CA (US); Stanley Shepherd, Morgan Hills, CA (US)

Correspondence Address: FOLEY & LARDNER, 2029 CENTURY PARK EAST, SUITE 3500, LOS ANGELES, CA, 90067, US

(73) Assignee: Maxtor Corporation

(21) Appl. No.: 11/750,853

(22) Filed: May 18, 2007

Related U.S. Application Data
(60) Provisional application No. 60/747,786, filed on May 19, 2006.

(51) Int. Cl. G11B 21/02; G11B 5/596

(52) U.S. Cl. 360/75; 360/78.04

(57) ABSTRACT

Embodiments of the present invention allow for detection of contact between a sensor, such as a data read/write head, and a surface, such as the magnetic surface of a disc. An actuator may be controlled to repeatedly seek a head across a surface of a disc. A touchdown actuation pattern may be provided to the head during the seeks and a set of measurements are made to detect contact.

### CROSS-REFERENCE TO RELATED PATENT APPLICATIONS

This application claims priority from U.S. Provisional App. Ser. No. 60/747,786, filed May 19, 2006, the contents of which are incorporated by reference herein in their entirety.

### BACKGROUND

Embodiments of the present invention relate to fly height adjustment of read/read/write heads in storage devices and, more particularly, to touchdown detection during a writing of servo data.

An important device in any computer system is a data storage device. Computer systems have many different places where data can be stored. One place for storing massive amounts of data and instructions is a disc drive. The disc drive has one or more discs, each with two surfaces on which data is stored. The surfaces are coated with a ferro-magnetic medium with regions that are magnetized in alternate directions to store the data and instructions. The coated surfaces are computer-readable media holding computer-readable data and computer-readable and computer-executable instructions.

The discs are mounted on a hub of a spindle motor for rotation at an approximately constant high speed during the operation of the disc drive. An actuator assembly in the disc drive moves magnetic transducers, also called read/write heads, to various locations relative to the discs while the discs are rotating, and electrical circuitry is used to write data to and read data from the media through the read/write heads. Data and instructions are stored in the media of one or both of the surfaces of each disc. The disc drive also includes circuitry for encoding data and instructions written to the media and for decoding data and instructions read from the media. A microprocessor controls most operations of the disc drive, such as transmitting information including instructions or data read from the media back to a requesting computer and receiving data or information from the requesting computer for writing to the media.

Information representative of data or instructions is stored in tracks in the media. In some disc drives, information is stored in a multiplicity of concentric circular tracks in the media on each disc. In other disc drives, information is stored in a single track that forms a continuous spiral in the media on each disc. A read/write head is positioned over a track to write information to or read information from the track. Once the operation is complete, the read/write head may be controlled to move to a new, target track, to write information to or read information from the target track. The movement takes place in the following modes. The read/write head is moved along an arc across the media of a disc in a seek mode to position it near the target track. The read/write head is then positioned over the target track during a track-and-follow mode, also called a tracking mode, to read or write the information stored in the target track. Servo information is read from the target track by the read/write head, and a feedback control system determines a position error signal from the servo information. If the read/write head is not in a correct position, it is moved to a desired position over the target track in response to the position error signal.

Each read/write head is typically located on a slider that is supported by the actuator assembly. The actuator assembly is controlled to position the read/write head over the media of one of the discs. Each slider is attached to a load spring supported by an arm. The arms in the actuator assembly are rotatably mounted to an actuator shaft through bearings and are rotated about the actuator shaft by a voice coil motor to move the read/write heads over the media. The bearings and the actuator shaft are also called a pivot. The voice coil motor includes a voice coil mounted to the actuator assembly opposite to the arms. The voice coil is immersed in a magnetic field of an array of permanent magnets placed adjacent to the actuator assembly. The feedback control system applies current to the voice coil in a first direction to generate an electromagnetic field that interacts with the magnetic field of the magnets. The interaction of the magnetic fields applies a torque to the voice coil to rotate the actuator assembly about the pivot, and the actuator assembly is accelerated to move the read/write head to a new position. The feedback control system may then apply current to the voice coil in a direction opposite to the first direction to apply an opposite torque on the actuator assembly. The opposite torque may be used to decelerate the actuator assembly and position the read/write head over a target track. The opposite torque may also be used to accelerate the actuator assembly to a different position.

Each slider is a small ceramic block that flies over the media of one of the discs. When the disc rotates, air flow is induced between the slider and the media, causing air pressure which lifts the slider away from the media. The slider has an air bearing surface that is aerodynamically shaped to give the slider lift when air flows between the slider and the media. The load spring, described above, produces a force on the slider directed toward the media. The forces on the slider equilibrate such that the slider flies over the media at a nominal fly height. The fly height, also called clearance, is a distance between the slider and the media, and is a measure of an amount of air available to interact with the air bearing surface of the slider as it is aerodynamically supported over the media. The fly height of the slider affects the fly height of the read/write head carried by the slider, which is a distance between the media and the read/write head. The fly height of the read/write head should be approximately uniform so that the read/write head is capable of reading data from, and writing data to, the media.

Several variables affect the fly height of a slider. For example, fly height is impacted by a curvature of a disc, vibrations of the disc caused by the spindle motor, and roughness and defects in the media. Fly height is also affected by a variation in the aerodynamics of the slider due to changes in its orientation and position during flight.

A major goal among many disc drive manufacturers is to continue to increase disc drive performance while still maintaining disc drive reliability. One feature of a disc drive that impacts both disc drive performance and disc drive reliability is the flying height of the head. If the flying height of the head is too high, then poor magnetic performance may result, and such poor magnetic performance may lead to an increased bit error rate, slower read and write operations, and a decrease in possible storage density. On the other hand, if a flying height of a head over a recording medium is too low, then the head may contact the recording medium, and such contact may damage the head and the recording medium.

The head comprises an integrated transducer containing a read and write structure. The read structure generally comprises a read element for reading data from the recording medium. The write structure generally comprises a write pole, a write yoke, and write coils surrounding the write yoke, where the write structure allows for writing data to the recording medium.

During write operations in various disc drives, a current may be passed through one or more write coils that surround at least a portion of a write yoke. The current in the write coils produces a magnetic flux in the write yoke that is able to be focused at a write pole, and the magnetic flux is able to pass from the write pole to a recording medium so as to write data to the recording medium. The current in the write coils that is provided during write operations also causes the write coils to generate heat that is spread to surrounding portions of a head that includes the write coils. Such heat provided by the write coils during write operations may lead to write pole tip protrusion (WPTP) in which thermal distortions of materials within the head result in a lowering of a flying height of the head.

During read operations in various disc drives, there is generally no current passed through the write structure and, thus, no heat generated by the write structure to maintain WPTP. As a consequence, in such disc drives, a flying height of a head may be unnecessarily too high during read operations unless the flying height of the head is lowered by another source. Various schemes have been proposed for providing flying height adjustment (FHA) to adjust a fly height or flying height (FH) of a head, so as to allow for lowering the flying height of the head during read operations.

Decreasing the fly height improves the signal-to-noise ratio in the read signal, thereby enabling higher recording densities (radial tracks per inch and linear bits per inch). To this end, designers have exploited the expansion properties of the head (e.g., the slider and/or transducer) by incorporating a heater to control the temperature of the head and thereby the fly height. Increasing the temperature causes the head to expand, thereby moving the transducer closer to the disc surface. However, decreasing the fly-height increases the chances the head will collide with the disc causing damage to the head and or recording surface. This is of particular concern during seek operations due to the increased velocity of the head with respect to the disc and the potentially large fluctuations in fly-height due to vibrations in the actuator arms.

Head touchdown occurs when the head effectively or substantially contacts the disc. Head touchdown detection is especially useful in disc drives which provide fly height adjustment.

Disc drives have detected head touchdown using a heater in the head. The disc drive supplies power to the heater so that the head thermally expands and protrudes towards the disc, thereby lowering the fly height. The power is supplied to the heater while the head is positioned over test tracks or other non-data-bearing areas of the disc and does not perform read or write operations. As more power is supplied to the heater, head touchdown is monitored. However, this approach is time consuming, often requiring a large number of disc revolutions (such as 100 disc revolutions) to accumulate sufficient data points.

Disc drives have also detected head touchdown by writing high-frequency patterns in servo fields and detecting the amplitude of such patterns. However, this approach requires new channel features and significant firmware changes and is subject to channel setting, channel noise and the like.

Disc drives include servo systems that position the head relative to the disc using a position error signal (PES) during track following, as is typical during read and write operations. The servo system reduces the impact of vibration or other external disturbances on the PES to avoid track misregistration. However, the servo system can also reduce the sensitivity of the PES to head touchdown. As a result, the servo system may be unable to distinguish or detect head touchdown (“false negative”), thereby damaging the head.

Traditionally, the machine used to write servo information is called a servo writer. Typically, a drive to be servo written must be servo written with its cover removed or with at least two external openings to permit the insertion of the clock head and the arm positioning mechanism when the drive is mounted on the servo writer. Consequently, they require a clean room environment to avoid contamination of the disc drive. A self-servo writer on the other hand provides a non-invasive alternative. In self-servo writing a disc drive is initially blank and it essentially writes its own servo data. In self-servo writing, the task of touchdown detection becomes a challenging problem because the discs are initially blank with no initial position information written on them to be used as a reference.

Many of the prior touchdown detection methods collected particular signals such as PES, BIAS, or VGA to decide if touchdown had occurred. However, in self-servo writing as explained above there is no reference pattern on the media at the beginning of the process. Using a default actuation like the type that is currently in place for non-self-servo write, does not work effectively because of the existence of a wide tolerance of the fly height clearance from the incoming parts. Furthermore, controlling the arm around neighborhood of particular radius, using BEMF (Back Electro-Magnetic Field) velocity as the feedback signal would not work well either because the bias is generally inaccurate, which could lead to the arm floating to a different radius gradually.

### SUMMARY

Embodiments of the present invention allow for detection of contact between a sensor, such as a data read/write head, and a surface, such as the magnetic surface of a disc. An actuator may be controlled to repeatedly seek a head across a surface of a disc. A touchdown actuation pattern may be provided to the head during the seeks and a set of measurements are made to detect contact.

In one embodiment of the invention, a method comprises controlling an actuator to move a head across a surface of a disc systematically in a plurality of passes based on back electromagnetic field measurements; and providing a touchdown actuation pattern to the head for each of the plurality of passes of the head across the surface of the disc.

In another embodiment, a method comprises utilizing an iteratively updated open loop control to determine substantially repeatable seek motions of a head across a surface of a disc; launching the head using the open loop control in a seek motion across a surface of the disc; and selectively turning on and off a signal to the head during the seek motion to detect touchdown.

In another embodiment, an apparatus comprises a controller configured to control an actuator to move a head across a surface of a disc systematically in a plurality of passes based on back electromagnetic field measurements; and the head configured to be actuated based on a touchdown actuation pattern to the head for each of the plurality of passes of the head across the surface of the disc.

Other features, embodiments, and advantages of the present invention will be apparent from the following specification taken in conjunction with the following drawings.

### BRIEF DESCRIPTION OF THE DRAWINGS

FIG. 1 is an exploded view of a disc drive according to an embodiment of the present invention;

FIG. 2 is a diagrammatic plan view showing the configuration of a recorded spiral track on a magnetic disc in accordance with principles of the present invention;

FIG. 3 is a diagrammatic graph showing an isomorphic mapping of the recording band of the magnetic disc of FIG. 2 onto a rectangular region;

FIG. 4 is a simplified, high-level block diagram showing the relationship between a disc drive head-disc-assembly, a host computer and a self-servo writer embodying the invention;

FIG. 5 is an outlines of steps in a typical self-servo write approach;

FIG. 6 illustrates a radial profile of motion of a head across a stroke in accordance with an embodiment of the present invention;

FIG. 7 illustrates a control loop according to an embodiment of the present invention;

FIG. 8 illustrates a table describing the parameters relating to the touchdown detection mechanism according to an embodiment of the present invention;

FIG. 9 is a graph of PES frequency distribution during head touchdown; and

FIG. 10 is a high level description of an embodiment of the present invention.

### DETAILED DESCRIPTION OF THE EMBODIMENTS

In the following detailed description of exemplary embodiments of the present invention, reference is made to the accompanying drawings which form a part hereof, and in which are shown by way of illustration specific exemplary embodiments in which the present invention may be practiced. These embodiments are described in sufficient detail to enable those skilled in the art to practice the present invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the claims. In the following description, similar elements retain the same reference numerals for purposes of clarity.

The embodiments of the present invention described in this application are useful with all types of disc drives, including hard disc drives, zip drives, media storage drives, tape drives, and floppy disc drives.

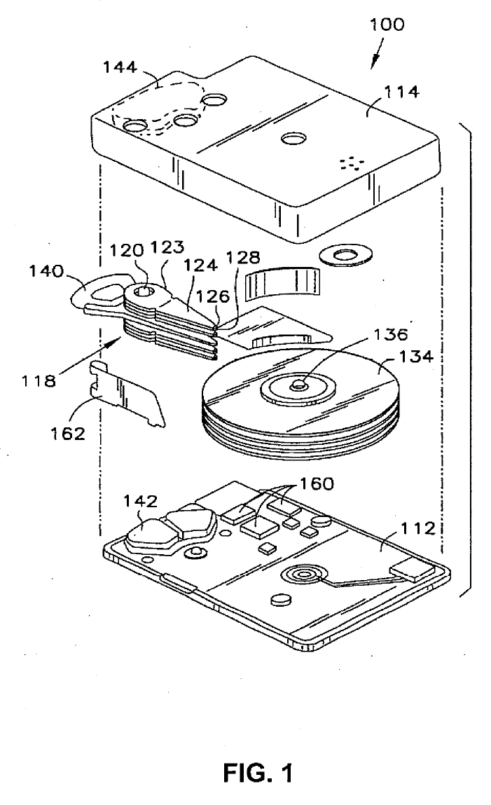

An exploded view of a disc drive is shown in FIG. 1 according to an embodiment of the present invention. The disc drive 100 includes a housing or base 112 and a cover 114. The base 112 and over 114 form a disc enclosure. An actuator assembly 118 is rotatably mounted to an actuator shaft 120, and the actuator shaft 120 is mounted to the base 112. The actuator assembly 118 includes a comb-like structure of a plurality of arms 123. A load spring 124 is attached to each arm 123. The load springs 124 are also referred to as suspensions, flexures, or load beams. A slider 126 is attached to an end of each load spring 124, and each slider 126 carries a read/write head 128. Each slider 126 is a small ceramic block which is passed over one of several discs 134.

The discs 134 each have two surfaces, and information is stored on one or both of the surfaces. The surfaces are coated with a magnetizable medium that is magnetized in alternate directions to store the information. The surfaces are computer-readable media holding the information including computer-readable data and computer-readable and computer-executable instructions. The information is arranged in tracks in the media of the discs 134. The discs 134 are mounted on a hub 136 of a spindle motor (not shown) for rotation at an approximately constant high speed. Each slider 126 is moved over the media of one of the discs 134 by the actuator assembly 118 as the discs 134 rotate so that the read/write head 128 may read information from or write information to the surface of the disc 134. The embodiments of the present invention described herein are equally applicable to disc drives which have a plurality of discs or a single disc attached to a spindle motor, and to disc drives with spindle motors which are either under a hub or within the hub. The embodiments of the present invention are equally

applicable to disc drives in which information is stored in a multiplicity of concentric circular tracks in the media of each disc, or in disc drives in which information is stored in a single track arranged as a continuous spiral in the media of each disc.

Each slider 126 is held over the media of one of the discs 134 by opposing forces from the load spring 124 forcing the slider 126 toward the media and air pressure on an air bearing surface of the slider 126 caused by the rotation of the discs 134 lifting the slider 126 away from the media. It should also be noted that the embodiments of the present invention described herein are equally applicable to sliders 126 having more than one read/write head 128. For example, magneto-resistive heads, also called MR heads, have one head used for reading data from media and a second head for writing data to the media. MR heads may have an additional heads used for other purposes such as erasing the media.

A voice coil 140 is mounted to the actuator assembly 118 opposite the load springs 124 and the sliders 126. The voice coil 140 is immersed in a magnetic field of a first permanent magnet 142 attached within the base 112, and a second permanent magnet 144 attached to the cover 114. The permanent magnets 142, 144, and the voice coil 140 are components of a voice coil motor which is controlled to apply a torque to the actuator assembly 118 to rotate it about the actuator shaft 120. Current is applied to the voice coil 140 in a first direction to generate an electromagnetic field that interacts with the magnetic field of the permanent magnets 142, 144. The interaction of the magnetic fields applies a torque to the voice coil 140 to rotate the actuator assembly 118 about the actuator shaft 120, and the actuator assembly 118 is accelerated to move the read/write head 128 to a new position. A current applied to the voice coil 140 in a direction opposite to the first direction results in an opposite torque on the actuator assembly 118. The opposite torque may be used to decelerate the actuator assembly 118 and position the read/write head 128 over a target track on one of the discs 134. The opposite torque may also be used to accelerate the actuator assembly 118 to a different position.

The disc drive includes one or more integrated circuits 160 coupled to the actuator assembly 118 through a flexible cable 162. The integrated circuits 160 may be coupled to control current in the voice coil 140 and resulting movements of the actuator assembly 118. The integrated circuits 160 may also be coupled to the read/write head 128 in the slider 126 for providing a signal to the read/write head 128 when information is being written to the media on the discs 134 and for receiving and processing a read/write signal generated by the read/write head 128 when information is being read from the media on the discs 134. A feedback control system in the integrated circuits 160 may receive servo information read from the media through the read/write heads 128. The feedback control system determines a position error signal from the servo information. If the read/write heads 128 are not in a correct position, they are moved to a desired position over a target track in response to the position error signal. The circuits 160 may include a microprocessor, a digital signal processor, or one or more state machines to control operations of the disc drive 100. The integrated circuits 160 may also include memory devices such as EEPROM and DRAM devices and modulation and amplification circuits.

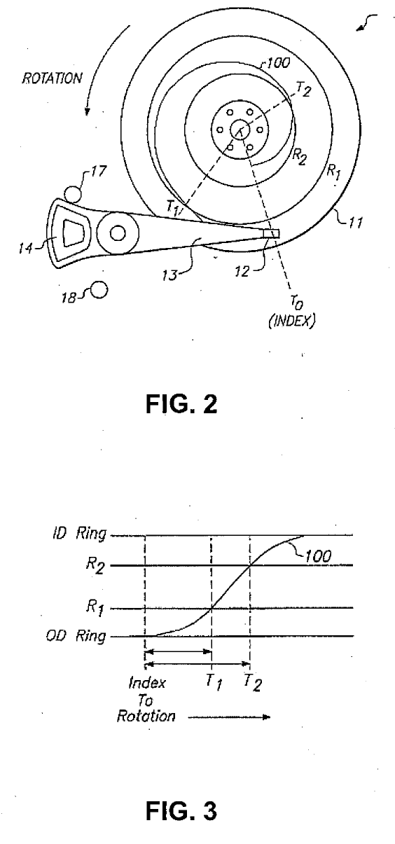

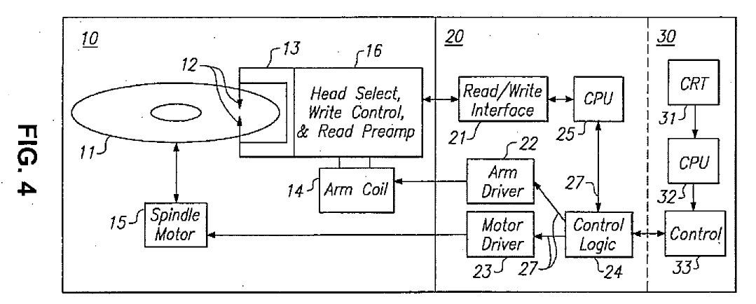

Now referring to FIG. 2, before disc 11 is servo written, it is not generally possible to selectively and precisely position head 12 at any particular track location (e.g., at track R.sub.1 or R.sub.2) due to the lack of positional feedback from disc 11. It is possible, however, to move head 12 “open-loop” to head positions at the outer diameter (OD) and inner diameter (ID) which form the boundaries of the disc's potential recording band using crash-stops 17 and 18 for reference. Since head 12 can be moved open-loop from the OD ring to the ID ring (or vice versa), it is possible to write a spiral track 100 across the usable disc surface (“recording band”) between the OD and ID rings by seeking across the disc while concurrently writing a constant amplitude, high frequency signal. If voice coil 14 were then energized to displace head 12 to the recording band and if no current were subsequently applied to voice coil 14, then arm 13 would remain stationary and once per revolution, high frequency information recorded in spiral track 100 would pass under head 12. As shown in the linearized data band representation illustrated in FIG. 3, at track position R.sub.1, spiral track 100 would pass under head 12 at a time offset T.sub.1 (relative to the index T.sub.0) and at track position R.sub.2, spiral track 100 will pass under head 12 at a different time offset T.sub.2. Thus the time offset from time T.sub.0 to the detection of a spiral track 100 may be used to provide positional feedback on radial head location, provided that time T.sub.0 can be reliably determined while the head is operated within the recording band.

FIG. 4 shows a high level block diagram of an in situ servo writer 20 in accordance with the present invention. Three main functional blocks are illustrated. The first is head-disc-assembly (HDA) 10 which is the disc drive to be servo written (and which is not part of the servo writer). HDA 10 contains magnetic disc 11, head(s) 12, actuator arm 13, voice coil motor 14, spindle motor 15, and head control circuitry 16 that writes, reads, and selects the appropriate one of head(s) 12. Aside from the spindle motor electronics, all of the HDA electrical signals normally pass through a single connector that is accessible from the exterior of HDA 10. The second functional block is servo writer 20. Servo writer 20 includes a read/write interface 21, an arm driver 22, and a motor driver 23, the latter drivers being controlled via control logic 24 governed by main high speed microprocessor (CPU) 25 via CPU bus 27. Servo writer 20 is operated via the third functional block, a host computer 30. Host computer 30 is conventional and typically includes a display tube (CRT) 31, a microcomputer CPU 32, and control circuitry 33 to interface with control logic 24 of the servo writer 20. Host computer 30 may be programmed to operate several servo writers 20 concurrently and is the highest level user interface to the servo writer(s) 20. This host computer 30 down-loads software, starts and stops servo writer operation, and up-loads test results to be dumped into a database for e.g. later statistical analysis.

To begin servo writing, HDA 10 is installed into a test fixture forming a part of servo writer 20. Disc 1 is spun up using the spindle motor driver 23 which, in this embodiment of the invention, contains an 8-bit microprocessor and comparators (not shown) that are used to characterize the timing of multiple zero crossings of the spindle motor. The spindle motor driver's microprocessor can therefore communicate rough circumferential position back to main high speed processor 25 via CPU bus 27. When the discs are up to speed, all the heads and discs are checked for functionality and quality both at the ID and the OD of the stroke of the arm. The actuator arm is controlled by a constant current H-Bridge output stage amplifier that is driven from a high resolution DAC. A low gain back-EMF sensing amplifier is used to sense actuator velocity and thereby determine when the crash-stops are encountered by actuator 13. An amplifier may also be used to help generate a constant arm velocity during erasure seeks, in the event that in situ disc erasure is required.

In one embodiment of the invention, a microprocessor controlled servo writer which includes a read/write interface, an arm driver, and a motor driver, is noninvasively attached to a target drive and a host computer that provides a user-level interface for controlling servo writer operation. The drive is initially blank and contains no servo information. Although closed-loop servo controlled arm positioning is not yet possible, it is possible for the servo writer to move the drive heads to the crash-stops at the outer diameter (OD) and inner diameter (ID). The initial phase of servo writer operation is to test and characterize the drive heads at the OD and ID so that read/write operations can be tuned such that the readback signal amplitude is relatively consistent from OD to ID, notwithstanding the occurrence of head skew, velocity changes, and head-to-disc spacing changes from OD to ID. A clock track is then written at the OD.

The present servo writer of the above embodiment does not require (but does not preclude) the insertion of a dedicated clock head. Instead, it can write a clock track utilizing, for example, feedback from the output of disc drive's spindle motor. A microprocessor is programmed to generate an accurate virtual clock signal derived by reading and characterizing the actual data read from the recorded clock track (a more conventional clock track having “closure” may also be utilized, if desired). The next phase of the servo writing process involves tuning an open loop seek from OD to ID. Initial tuning is performed by executing progressively stronger OD to ID seeks until the back EMF from the discs drive's actuator coil indicates that the ID has just been reached.

The acceleration, coast, and deceleration phases of the arm seek are then tuned so that the OD to ID seek takes a predetermined amount of time. For example, a spiral which takes two revolutions to write will require a tuned seek of exactly two rotational periods of the disc drive's spindle motor. Once a repeatable, tuned seek profile is established for the desired spiral configuration, a plurality of high frequency spiral tracks, with embedded “missing bits” for high resolution timing are written during the execution of tuned seeks starting at equidistant points about the OD, which points may be determined with reference to the clock track. The head is then perturbed slightly from the OD into the spiral tracks. Spiral track peak counts and missing bit data are read from the disc and that information is then characterized in a table stored in RAM (in the servo writer). A VCM is locked to the missing bit data in the spirals to, inter alia, accurately track the disc angular position. As the head is moved radially, the detected spiral peaks shift in time relative to a once-per-rotation time index mark, however the missing bit data does not, so the arm servo can be locked to the time offset from the triggering of a time index mark to the detection of a signal peak occurring due to the detection of a recorded spiral. Having thus locked the VCM and the arm servo, data wedges can be written with the disc drive's heads by multiplexing between reading spirals and dumping (writing) wedges. The integrity of the written wedges is verified and then the spirals may be overwritten with user data, as they are no longer required.

Briefly, a method for servo writing a disc drive in accordance with an embodiment of the present invention generally includes the steps of connecting a target disc drive, characterizing the heads at the ID and OD, writing a clock sync track at the OD, timing a seek profile, writing a set of high frequency spiral tracks, moving the head(s) into the recording band, characterizing the spiral peak counts and phases, establishing VCM servo control (i.e., servo “locking”), establishing arm servo control, moving the head(s) to a starting track, and finally, servo writing and verifying the entire drive.

Embodiments of the present invention allow for touchdown detection. In some of the embodiments, an in-drive detection of touchdown with the electronics of the disc drive is utilized, such that there is control of a voice coil motor with back electromagnetic field measurements in synchronization with a set of zones to seek across the media systematically for the touchdown operation.

An embodiment of the present invention comprises an self-servo-spiral write process in which the fly height actuator elements are properly calibrated before the start of the spiral write step, and thus fly height actuation can be properly set during self-servo spiral write step.

As described earlier, many of the prior touchdown detection methods collected particular signals such as PES, BIAS, or VGA to decide if touchdown had occurred. However, self-servo-write presents a special case where there is no reference pattern on the media at the beginning of the process. Using a default actuation like the type that is currently in place for non-self-servo write, does not work effectively because of the existence of a wide tolerance of the fly height clearance from the incoming parts. Furthermore, controlling the arm around neighborhood of particular radius, using BEMF velocity as the feedback signal would not work well either because the bias is generally inaccurate, which could lead to the arm floating to a different radius gradually.

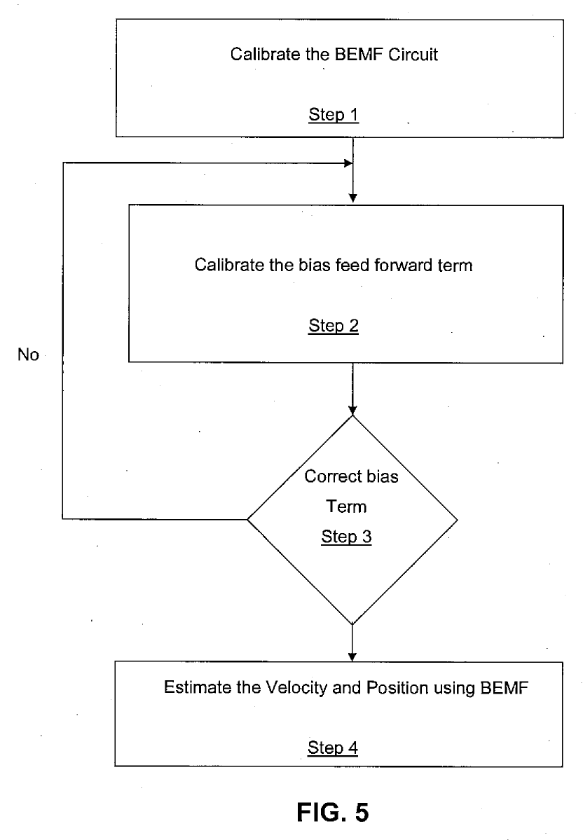

A method according to an embodiment of the present invention assumes a typical self-servo write approach as shown in FIG. 5. In step 1, the BEMF circuit is calibrated. In step 2, a bias feed forward term obtained by launching from the crash-stop and seeking through to the ramp, is calibrated. In step 3, above step 2 is performed a couple of times to arrive at the correct bias table (or feed-forward table). And, at step 4, the velocity and position is estimated using BEMF reading as the feedback signal.

A method in accordance with an embodiment of the present invention, for seeking a head from one end of a stroke of the actuator arm assembly to another end of the stroke of the actuator arm assembly, is as follows. A start of a seeking motion is determined by resting against a crash-stop or the edge of the ramp assembly. In the instant invention, the motion is accomplished by an acceleration pulse followed by position control based upon an integrated actuator velocity as measured by the back electromagnetic field of the voice coil motor. The size of the acceleration pulse, and the back electromagnetic field scaling to actuator velocity, are characterized on a drive by drive basis and are continually adjusted such that the motion from one crash-stop to the other nominally occurs in a targeted amount of time.

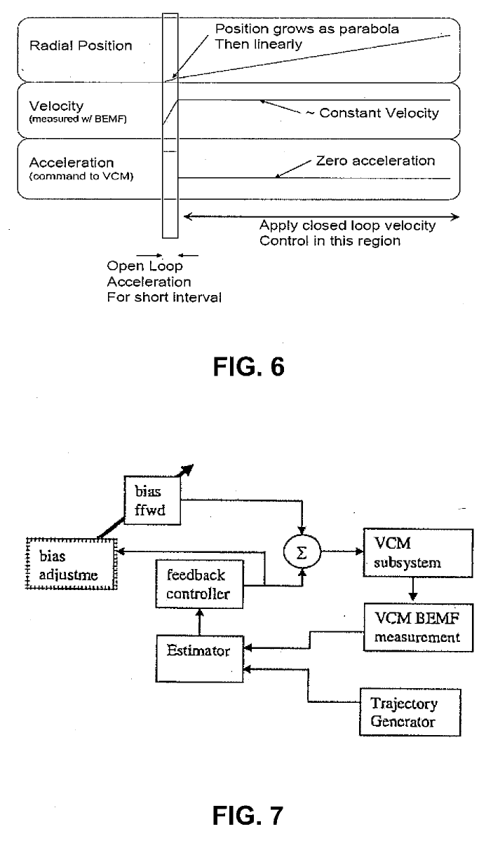

Specifically, with the back electromagnetic field sensing circuitry, it can be problematic to apply large or quickly changing currents and measure the back electromagnetic field of the voice coil motor. Thus, in order to reach a constant velocity of the motion of the actuator arm assembly, an acceleration pulse, or open loop pulse, is applied. Referring now to FIG. 6, with the acceleration pulse, the radial position of the head grows as a parabola, with the velocity increasing as well. After applying this larger current, once it is estimated that the necessary velocity is reached, the learned normal current is applied in a closed loop as mentioned above. In this case, the radial position of the head changes linearly, the velocity remains constant, and there is no acceleration. Practically, for about 1/100 of a disc revolution, the acceleration pulse is applied before the current necessary for a constant velocity is applied.

As mentioned above, this adjustment occurs continuously, but there will be an initial calibration phase. The calibration phase allows for the estimation of how much acceleration and velocity with which to move the actuator arm assembly. In calibrating the movement of the head, there are several limitations to keep in mind. There are mechanical hard limits to how much the actuator arm assembly can rotate, typically rotating at a 30 to 35 degree angle on the ramp drive. The angle of the head over the disc varies usually between 22 to 26 degrees. There are also hard limits that prevent the head from contacting spindle clamps of the spindle connected to the disc.

Calibration begins with moving the head to a farthest reach toward an inner diameter of the disc. Current is applied to have a constant bias against a crash-stop in order to obtain a repeatable radial launch point for the spiral seek. An open loop command of acceleration is applied, followed by a bias to keep the velocity constant. The back electromagnetic field is monitored, then the process is repeated, and identification of when the head hits a mechanical stop (like a ramp or crash-stop) can be made accordingly.

The back electromagnetic field and velocity is estimated through this process. Associated with the actuator arm assembly is a coil. Because the coil is moving through a magnetic field, voltage is produced. The voltage across the coil can be measured. This value can be utilized to deduce how much of the voltage is due to the back electromagnetic field. Specifically, by subtracting out an expected voltage drop, given the amount of current being applied to move the actuator arm assembly, the back electromagnetic field voltage can be estimated. Ideally, the back electromagnetic field value is directly proportional to a velocity of the actuator arm assembly. Thus, obtaining the value of the back electromagnetic field voltage also provides an estimate of a value of the velocity of the actuator arm assembly.

An edge of a crash-stop or ramp assembly may be detected using the back electromagnetic field of the voice coil motor. At sufficiently low velocities and commanded current, the suspension will bounce on the edge of the ramp assembly rather than unload the head. The detection of the edge of the crash-stop or ramp assembly is needed for several reasons. First, this detection establishes a repeatable radial launch point for spiral seeks during touchdown detection. Second, this detection allows for establishing a position profile across the stroke. After reaching an end of the stroke, a bias force is applied to bring the suspension to rest against the crash-stop or ramp assembly. This is followed by a seek across the stroke in the opposite direction.

An embodiments of the present invention utilizes repetitive seeks across a stroke of the actuator arm assembly between an outer diameter crash-stop (or ramp assembly) at an outer diameter of the disc and an inner diameter crash-stop (or ramp assembly) at an inner diameter of the disc. Statistically, a radial position of the head during nominally identical seeks is not repeatable. Experimental evidence suggests that repeated seeks will be normally distributed around an average seek. The width of the distribution is most strongly correlated to the time since the spiral was launched. This is the time since an “absolute” position was attained by bias force against the crash-stop or ramp assembly. Since there exists a required accuracy to the positioning of the head in order to prevent head damage, a lower bound on the seek velocity is imposed. An actual value of the seek velocity is dependent upon the particulars of the mechanisms involved in the disc drive.

The block diagram in FIG. 7, describes an overall structure of the control system used for writing the spirals across the stroke, according to an embodiment of the present invention. The spiral writing motion is used as a repeatable motion that will be perturbed if the read/write head is moved too close to the disc surface. The bias adjustment block of FIG. 7 is used during the learning phase which comprises the steps 2 and step 3 described above, to determine the average VCM command (bias) required to move the arm across the stroke at a targeted velocity (as measured by VCM BEMF), After several iterations, the bias will be learned and stored in a table. The objective of the bias adjustment is to separate the VCM command into repeatable and non-repeatable components. The feedback control signal should have no repeatable component from one spiral motion to the next. Repeatable components of the feedback control signal will be correlated to fly height commands to comprise a touchdown detection method.

In an embodiment of the present invention, when the head makes contact with the disc surface, we expect a perturbation to the nominal motion. The feedback control will react to this unexpected perturbation in a repeatable way. This repeatable component of the feedback control will allow us to conclude that touchdown has occurred.

In one embodiment of the present invention, the process alternates between the fly-height adjustment and the bias recalibration to minimize the non-touchdown related repeatable feedback control signal contents.

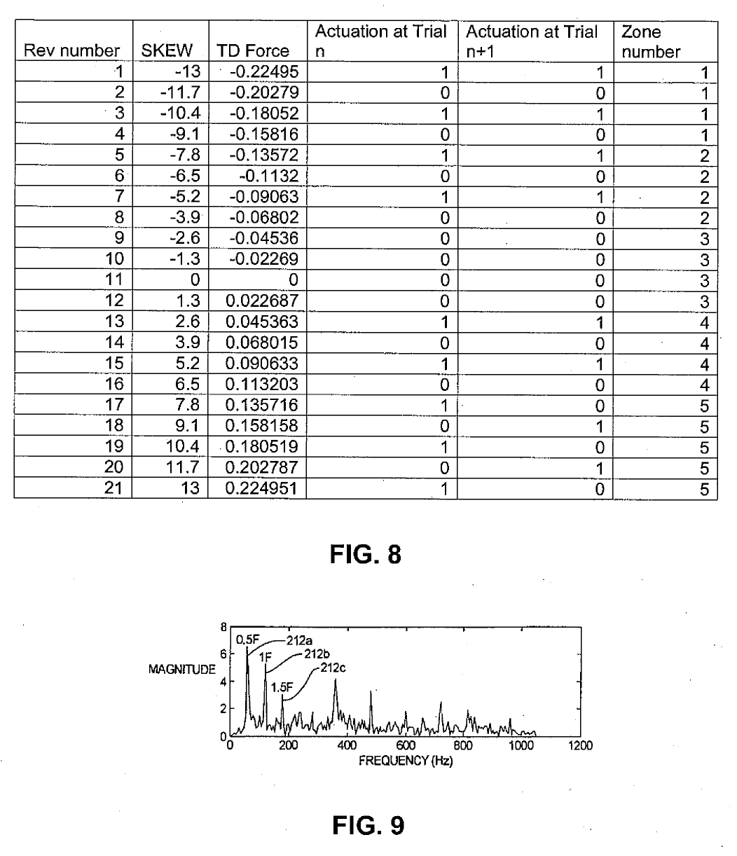

In one embodiment of the present invention, a table such as the one shown in FIG. 8 is used in the calibrating sequence. The table is based on the assumption of using a 6 inch per second coasting velocity disc. The drive spins at 7200 RPM, thus it takes approximately 20 revolutions to seek across a 3.5 inch disc. All those numbers can be tweaked for other form factors and spindle RPM. As shown, the whole stroke is divided into 5 zones wherein the first zone is closest to OD, and the 5^{th} zone is closest to ID. Each zone comprises a number of disc revolutions represented as Rev number. At a particular Rev number, there are values for a number of variables in the table. The first variable specifies the skew angle which is the angle between the longitudinal axis of the head with respect to a line tangent to an underlying track at that revolution number. The second variable specifies the amount of force generated (denoted as TD Force) in case of a touchdown of the head at that skew angle. In this example, while we seek across the disc, the fly height actuation is enabled and disabled every other revolution. This represents the touchdown actuation pattern of this example. The value 1 in the actuation at Trial n or n+1 column denotes that an actuation is enabled at that trial. In the middle of the stroke where the skew angle is too small to generate enough centrifugal force, the actuation is not used.

During each actuation, the estimated bias value change (difference from the pre-calibrated bias value) is recorded for every revolution. The actuation pattern of a particular zone is controlled so that the combined touchdown actuation pattern of the current trial (n) and previous trial (net) is formed as a contiguous alternate touchdown actuation pattern.

In this example, the touchdown actuation pattern in zone 1 is formed as 1, 0, 1, 0, 1, 0, 1, 0 while touchdown actuation pattern in zone 5 is formed as 1, 0, 1, 0, 1, 0, 1, 0, 1, 0. Therefore, if the previous trial has an odd number of actuations in its pattern, then the subsequent trial would need to reverse the touchdown actuation pattern. Furthermore, in the above embodiments, for each actuation value, a couple of trials are performed. When touchdown happens on a particular zone, the actuation value will be recorded to calculate the clearance, and subsequently the actuation in this zone will be disabled in further trials to prevent burnishing of the head.

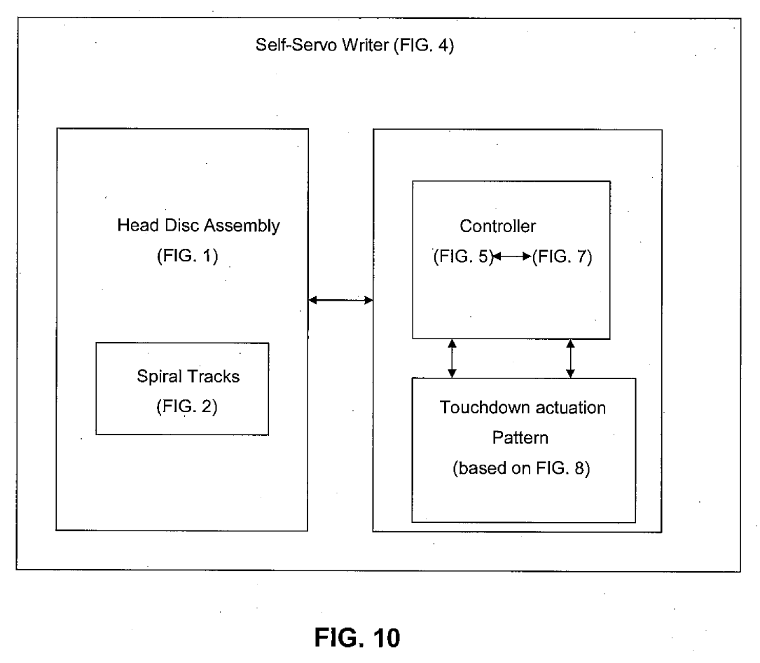

With the above formulation, the collected data will behave like ½ F DFT data that was described in the U.S. Pat. No. 7,158,325B1, the contents of which are incorporated herein in their entirety by reference. The idea of using PES harmonics presented in that patent is a new methodology that accurately and quickly detects touchdowns. It takes advantage of the unique PES signature during touchdown to achieve the best signal-to-noise ratio. Generally, the heater is turned on every other revolution so a bias force change of half of the spindle frequency is injected into the servo systems. It has been noted that the PES degradation mostly comes from the power concentrated at half F and the harmonics of the half F like 1F, 1.5F, etc., as shown in FIG. 9. The fundamental frequency, i.e., the half F has the most energy. Typically, a normal drive should not have a half F so the half F is the unique PES signature during touchdown. Even if there is a small half F PES during track-follow (heater off), this method still dramatically boosts the SIN. For example, assuming 0.5% of the total PES variance is half F when heater is off. During touchdown with heater on there is a 50% PES variance degradation half of which is the half F. Therefore, the S/N using PES Variance method is 0.5, and the S/N using half F is 50.

In one embodiment of the present invention, the discrete frequency of touchdown actuation can be set to the heater frequency or harmonics or sub-harmonics thereof. Likewise, the heater frequency can be set to the disc rotation frequency or harmonics or subharmonics thereof. For example, the heater can be cycled at alternate disc revolutions (heater turned on for one disc revolution, heater turned off for one disc revolution) and the discrete frequency can be set to the heater frequency (0.5 F). As another example, the heater can be cycled at ¼ disc revolutions (heater turned on for ⅛ disc revolution, heater turned off for ⅛ disc revolution) and the discrete frequency can be set to the heater frequency at the fourth harmonic (4F).

Although a PES has been measured, the signal related to head tracking that is measured at a discrete frequency to detect head touchdown can be an integration (nulli) signal, a head velocity signal, a bias current signal and combinations thereof. Although the PES magnitude has been measured with a power-frequency spectrum using a Fourier transform, the PES magnitude can be measured with other analyses or transformations that achieve the desired discrimination of head touchdown from vibration or other phenomena. Although the PES has been measured at a discrete frequency to detect head touchdown, the PES can be measured at multiple discrete frequencies in frequency bands that include harmonics and/or subharmonics of a root frequency such as one-half the disc.

Based on the above, in an embodiment of the present invention, the head comprises a heater, and the heater is continually adjusted in a control loop by an estimated value of power to be applied to the heater for a touchdown. A decrease in power decreases the heat and increases a fly height of the head from the disc surface, and an increase in the power increases the heat and decreases the fly height of the head from the disc surface. In one embodiment, a signal related to a tracking of the head is received, and a signal value related to a selected frequency of the signal is determined. The signal value is used to determine head touchdown. In an embodiment, the touchdown actuation pattern is realized by turning on and off the heater at a frequency that is substantially equal to the selected frequency.

The foregoing discussion of the invention has been presented for purposes of illustration and description and is not intended to limit the invention to the form disclosed herein. Although the description of the invention has included embodiments and certain variations and modifications, other variations and modifications are within the scope of the invention, as may be within the skill and knowledge of those in the art, after understanding the present disclosure. FIG. 10 illustrates one embodiment of the present invention incorporating some of the components explained. Although a disc drive has been described, head touchdown can be detected in other data storage devices with magnetic discs, compact discs, digital versatile discs and optical systems.

Those skilled in the art having the benefit of this description can appreciate that the present invention may be practiced with any variety of system. Such systems may include, for example, a video game, a hand-held calculator, a personal computer, a server, a workstation, a routing switch, or a multi-processor computer system, or an information appliance such as, for example, a cellular telephone or any wireless device, a pager, or a daily planner or organizer, or an information component such as, for example, a telecommunications modem, or other appliance such as, for example, a hearing aid, washing machine or microwave oven.

What is claimed is:

1. A method, comprising:
controlling an actuator to move a head across a surface of a disc systematically in a plurality of passes based on back electromagnetic field measurements; and
providing a touchdown actuation pattern to the head for each of the plurality of passes of the head across the surface of the disc.

2. The method of claim 1,
wherein each pass comprises a plurality of zones, and each of the said zones comprises a plurality of disc revolutions; and
wherein a touchdown is detected in each of the revolutions by measuring a value relative to a skew angle of the head.

3. The method of claim 1, further comprising:
performing repetitive seeks of the head across a stroke between mechanical stops to determine a fly height.

4. The method of claim 1,
wherein analysis is performed to ensure no touchdown is occurred for each of the passes.

5. The method of claim 1, wherein the method is used prior to servo writing in a self-servo writing process.

6. The method of claim 1, wherein the amount of velocity and acceleration necessary to move the actuator is estimated, wherein the velocity of the actuator is continually adjusted in a control loop, and
wherein a mechanical stop is detected using the measured actuator back electromagnetic field signal.

7. The method of claim 1,
wherein a signal value is obtained from a difference between the back electromagnetic field measurements and reference back electromagnetic field values; and
wherein the actuator is controlled based on the signal value.

8. The method of claim 7, wherein the signal value represents an increased drag or a perturbation in the movement of the head when a contact is made between the head and the surface of the disc.

9. The method of claim 1,
wherein the head comprises a heater,
wherein the heater is continually adjusted in a control loop by an estimated value of power to be applied to the heater for a touchdown; and
wherein a decrease in power decreases the heat and increases a fly height of the head from the disc surface, and an increase in the power increases the heat and decreases the fly height of the head from the disc surface.

10. The method of claim 9, further comprising:
receiving a signal related to a tracking of the head;
and determining a signal value related to a selected frequency of the signal,
turning on the heater at a heater frequency that is substantially equal to the selected frequency and;
using the signal value in determining head touchdown.

11. A method, comprising:
utilizing an iteratively updated open loop control to determine substantially repeatable seek motions of a head across a surface of a disc;
launching the head using the open loop control in a seek motion across a surface of the disc; and
selectively turning on and off a signal to the head during the seek motion to detect touchdown.

12. The method of claim 11, wherein the signal value represents an increased drag or a perturbation in the motion of the head when a contact is made between the head and the surface of the disc.

13. An apparatus comprising:
a controller configured to control an actuator to move a head across a surface of a disc systematically in a plurality of passes based on back electromagnetic field measurements and;
the head configured to be actuated based on a touchdown actuation pattern to the head for each of the plurality of passes of the head across the surface of the disc.

14. The apparatus of claim 13,
wherein each pass comprises a plurality of zones, and each of the said zones comprises a plurality of disc revolutions; and
wherein a touchdown is detected in each of the revolutions by measuring a value relative to a skew angle of the head.

15. The apparatus of claim 13, further comprising:
the controller configured to perform repetitive seeks of the head across a stroke between mechanical stops to determine a fly height.

16. The apparatus of claim 13,
wherein analysis is performed to ensure no touchdown is occurred for each of the passes.

17. The apparatus of claim 13, wherein the apparatus is used prior to servo writing in a self-servo writing process.

18. The apparatus of claim 13, wherein the amount of velocity and acceleration necessary to move the actuator is estimated, wherein the actuator velocity of the actuator is continually adjusted in a control loop, and
wherein a mechanical stop is detected using the measured actuator back electromagnetic field signal.

19. The apparatus of claim 13,
wherein a signal value is obtained from a difference between the back electromagnetic field measurements and reference back electromagnetic field values; and
wherein the actuator is controlled based on the signal value.

20. The apparatus of claim 19, wherein the signal value represents an increased drag or a perturbation in the movement of the head when a contact is made between the head and the surface of the disc.

21. The apparatus of claim 13,
wherein the head comprises a heater,
wherein the heater is continually adjusted in a control loop by an estimated value of power to be applied to the heater for a touchdown; and
wherein a decrease in power decreases the heat and increases a fly height of the head from the disc surface, and an increase in the power increases the heat and decreases the fly height of the head from the disc surface.

22. The apparatus of claim 13, further comprising:
the controller configured to receive a signal related to a tracking of the head, to determine a signal value related to a selected frequency of the signal, to turn on the heater at a heater frequency that is substantially equal to the selected frequency and to determine head touchdown using the signal value.
